(19) United States
(12) Patent Application Publication
(10) Pub. No.: US 2026/0270060 A1
(43) Pub. Date: Sep. 10, 2026

(54) SYSTEMS AND METHODS FOR USE IN DATA COMPLIANCE

(71) Applicant: MASTERCARD INTERNATIONAL INCORPORATED, PURCHASE, NY (US)

(72) Inventors: Mohamed Abouelenin, San Carlos, CA (US); Nicolas Schmidt, San Francisco, CA (US)

(21) Appl. No.: 19/070,961

(22) Filed: Mar. 5, 2025

(51) Int. Cl. H04L 9/08; H04L 9/06; H04W 12/47

(52) U.S. Cl. CPC H04L 9/0897; H04L 9/0643; H04W 12/47

(57) ABSTRACT

Systems and methods are provided for data compliance for certain data read from a device. One example method includes receiving, by a controller of a wireless device, via an antenna of the wireless device, an application protocol data unit (APDU) message from a near-field communication (NFC) enabled device, where the APDU message includes a credential, and hashing, using a one-way hashing function, or encrypting, using a public key associated with a remote commerce platform, the credential upon receipt of the APDU from the antenna. The method also includes flushing, by the controller, a secure memory of the controller after hashing or encrypting the credential and transmitting, by the controller, the hashed or encrypted credential to a communication module of the wireless device, whereby the hashed or encrypted credential is submitted to a first party to enable access to the wireless device.

### FIELD

The present disclosure generally relates to systems and methods for use in data compliance, and in particular, to systems and methos for use in imposing limited access to data in connection with near-field communication (NFC).

### BACKGROUND

This section provides background information related to the present disclosure which is not necessarily prior art.

In connection with data security, regulations are defined to impose limitations on data. The limitations may relate to the manner in which data is captured, stored and transmitted. The eligibility of data for compliance with such limitations is often defined based on the type of data being secured. For certain types of data, Payment Card Industry (PCI) compliance is required with regard to the Payment Card Industry Data Security Standard (PCI DSS). For other types of data, other compliance standards are imposed.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in data compliance for certain data read, from a device, via near-field communication (NFC);

FIG. 2 is a block diagram of an example computing device that may be used in the system of FIG. 1;

FIG. 3 is an example method that may be implemented in the system of FIG. 1 for use in data compliance for certain data read, from a device, via NFC, based on hashing of the data; and

FIG. 4 is an example method that may be implemented in the system of FIG. 1 for use in data compliance for certain data read, from a device, via NFC, based on encryption of the data.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Data security relies on various rules to ensure that data is maintained in a secure place, and that interactions based on that data are restricted. Data restrictions may be readily complied with in various environments, but not others. For example, imposing significant data security protocols on a user, or mobile device, may be cumbersome to implement and maintain. Consequently, limiting types of data in such devices may be preferred, in order to avoid data security restrictions.

Uniquely, the systems and methods herein provide for data compliance for certain data read, from a device, via near-field communication (NFC), where the data is hashed or encrypted to secure the same. In particular, for an interaction device, which receives sensitive data, the device is specifically configured to hash and/or encrypt the received data, as it is received (i.e., at the time of collection), and to promptly flush or delete memory thereof, whereby exposure of the data beyond the device is limited, or eliminated. The hashed or encrypted data may then be used in place of the data (e.g., account numbers, etc.), in data flows, to enable the data to be used to access goods, services, etc.

In this way, conventional wireless devices (e.g., card devices, etc.) are generally unchanged, while the systems and methods herein employ the same to provide for enhanced data security and secure access to product(s).

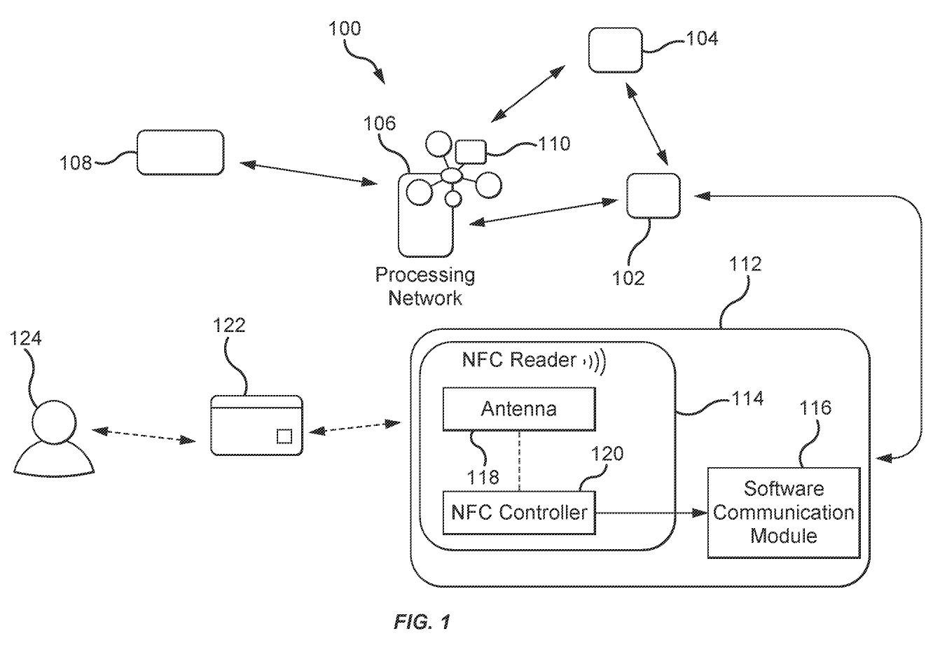

FIG. 1 illustrates an example system 100 in which one or more aspects of the present disclosure may be implemented. Although the system 100 is presented in one arrangement, other embodiments may include systems arranged otherwise depending, for example, on interactions with near-field communication (NFC) devices, accessibility to transactions/services, privacy regulations and/or concerns, etc.

In the illustrated embodiment, the system 100 generally includes a merchant 102, a payment service provider (PSP) 104 associated with the merchant 102, a processing network 106, and an issuer 108, each couple in communication through one or more networks. The one or more networks are represented by the arrowed lines in FIG. 1, and may include, without limitation, one or more local area network (LAN), wide area network (WAN) (e.g., the Internet, etc.), mobile network, virtual network, and/or combination thereof, and/or the one or more networks may include another suitable public and/or private network capable of supporting communication among two or more of the parts illustrated in FIG. 1, or any combination thereof.

The merchant 102 in the system 100 is generally associated with the sale of products, in the form, for example, of goods and services. The merchant 102 may include, for example, a rental agency, in which vehicles (e.g., cars, trucks, boats, recreational vehicles, airplanes, etc.) are accessible to a user in exchange for a fee (broadly, rental services). Other merchants may include those configured for delivery of products at the time of purchase in the form of vending machines, etc. Generally, the merchant 102 may be any party, which offers a user access, ownership, possession, etc., of one or more products, for a limited time, or forever.

In connection therewith, the PSP 104 is configured to initiate payment transactions on behalf of the merchant 102, such that the sale of products at the merchant 102 may be funded by an account associated with a user (e.g., user 124, etc.).

Relatedly, the processing network 106 is generally a payment processing network, which is configured to facilitate transactions through messaging between the PSP 104 and one or more financial institutions, including the issuer 108. The messaging generally relates to authorization, clearing and settlement for the transactions. The processing network 106 may include, for example, the MASTERCARD, VISA, DISCOVER, etc., processing network. As such, the processing network 106 may be configured to communicate with the PSP 104 and/or the PSP 104, issuer 108, or other financial institution through one or more standards, including, specifically, the ISO 8583 standard, ISO 20022 standard, etc. In this example embodiment, the processing network 106 includes a secure remote commerce platform 110. In particular, the secure remote commerce platform 110 is configured to enable enrollment of an account for payment at the merchant 102, for example. In the example embodiment (but not required in all embodiments), the secure remote commerce platform 110 is configured consistent with the secure remote commerce standard, which is defined by EMVCo®.

It should be appreciated that the secure remote commerce platform 110 may be standalone, or separate from the processing network 106, in other embodiments.

The issuer 108 is configured to issue a payment accounts to users. The payment accounts generally each include a primary account number (PAN), an expiration date, a card verification code (CVC), etc., which enable the accounts to be identified and used to fund transactions. The issuer 108 includes, generally, a bank or other financial institution, etc.

With continued reference to FIG. 1, the merchant 102 is associated with a wireless device 112, which is involved directly or indirectly in the products to be purchased by the user from the merchant 102. The wireless device 112 may include a POS terminal, for example, or may include a vending machine or vehicle, or other suitable device, etc. In general, however, the wireless device 112 is a point of interaction between the user 124 and the merchant 102. In the illustrated embodiment, the wireless device 112 is configured, for example, as a wireless (e.g., NFC, etc.) card or device reader.

As shown, the wireless device 112 includes a wireless chip 114 and a communication module 116. The wireless chip 114, in turn, includes an antenna 118 and a controller 120. As apparent from FIG. 1, the wireless communication in this embodiment includes near-field communication or NFC. As such, the antenna 118 is configured to receive and transmit data consistent with one or more NFC standards. In this example embodiment, the NFC controller 120 is configured to receive data from the antenna 118, as it is received by the antenna 118, and to provide data to the antenna 118, which is to be transmitted by the antenna 118.

Uniquely, as explained more below, the NFC controller 120 is further configured to generate a hash of data received from the NFC antenna 118, and to flush the data from memory of the NFC controller 120 once hashed (leaving only the hashed value). In this way, in this example, the data received, through the antenna 118, is not permitted beyond the NFC controller 120. The hashing may be consistent with a one-way hashing function, as explained below, which generates a value, from which the original data is not derivable. It should be appreciated that the memory of the NFC controller 120 is dynamic and secure, whereby there is no access thereto and the data is only accessible if transmitted by the NFC controller 120. Alternatively, the NFC controller 120 includes a public key, issued by the remote commerce platform 110 (which possesses a paired private key) to the merchant 102, and included in the NFC controller 120. In such embodiments, the NFC controller 120 is configured to encrypt data received from the NFC antenna 118 with the public key, and to flush the data from memory of the NFC controller 120 once encrypted (leaving only the encrypted value). In this way, in this example, the data received, through the antenna 118, is not permitted beyond the NFC controller 120 unless the data is encrypted by the public key. As above, the memory is secure and dynamic. In both options (i.e., hashing or encrypting), depending on the hardware architecture of the wireless device 112 (e.g., the NFC reader, etc.), the above operations may be performed as described at the wireless chip 114 (via the NFC controller 120) or they could be performed by a controller located just outside the wireless chip 114 and/or in the module 116 used to communicate securely with the wireless device 112.

In the above example, the wireless chip 114 may be an application specific integrated circuit (ASIC), or other hardware implemented device (e.g., programmable logic device (PLD), programmable gate array (PGA), etc.). Additionally, or alternatively, the wireless chip 114 may be programmable, via software, to implement the configuration above.

In a further alternative embodiment, the communication module 116 is configured to hash or encrypt the data from the antenna 118, where the NFC controller 120 is merely a conduit configured for communication to the communication module 116. In such embodiment, the communication module 116 is configured as the NFC controller as described above.

With continued reference to FIG. 1, the system 100 further includes a card device 122, which is associated with the user 124 and which is specific to an account issued to the user 124 by the issuer 108. The card device 122 in this embodiment includes a NFC-enabled payment card (e.g., a credit card, a debit card, a prepaid card, etc.), which is specific to an account and includes a funding primary account number (FPAN), expiration date and card verification code (CVC) specific to the account (broadly, credentials). The card device 122 is configured to transmit the credentials to the merchant 102 to fund transactions between the merchant 102 and the user 124. While the card device 122 is illustrated and described as a card in this example, it is more generally understood to be a mobile device 122. The mobile device may include any device configured to wirelessly communicate with the wireless device 112 to transmit account credentials. In this way, the mobile device 122 may include, without limitation, mobile phones including one or more virtual wallets, or smartwatches, rings, fobs, tags, etc., which may be included in the system 100 as the device 122 (or in lieu of, or in addition to, the device 122).

In connection with the above, the merchant 102 is configured to interact with the remote commerce platform 110 according to one or more models, which may be based on hashing of the credentials from the card device 122 and/or encrypting the credentials from the card device 122.

That is, for one or more transactions, the card device 122 is configured to interact with the wireless device 112 to deliver the credential(s) (e.g., FPAN, etc.) to the wireless device 112. The wireless device 112 is configured as explained below to be compliant with one or more data security protocols, including, for example, the Payment Card Industry Data Security Standard (PCI DSS). As such, the wireless device 112 is configured to convert PCI data into non-PCI data, or encrypt the same.

In particular, according to a first implementation, the user 124 instructs the merchant 102 to add the account associated with the card device 122 as a card on file with the merchant 102. The user 124, for example, may initiate the instruction at a webpage or application of the merchant 102. The instruction includes the FPAN, and also an expiration date of the card device 122 and a CVC from the card device 122. It should be appreciated that other data may be included in the instruction, as necessary or desired.

The merchant 102, in turn, is configured to submit an API request for enrollment of the account to the remote commerce platform 110. The request includes the FPAN, the expiration date and CVC for the account, as included in the instruction. The remote commerce platform 110 is configured to verify with the issuer 108 that the account is eligible for tokenization. If eligible, the remote commerce platform 110 is configured to determine a card ID (i.e., scrDigitalCardId) for the account. In one example, the remote commerce platform 110 is configured to submit the FPAN to a tokenization platform (not shown) as a request to provision a token. The tokenization platform is configured, in response, to generate the token, which is unique to the FPAN, to assign a card ID to the token, and then to return the card ID to the remote commerce platform 110. The tokenization platform is also configured to store the card ID, which is linked to the token, and the token, which is linked to the FPAN, for later resolution of the same.

It should be appreciated that the tokenization platform may be integrated with the remote commerce platform 110 in one or more embodiments, or both the remote commerce platform 110 and the tokenization platform may be part of the processing network 106.

The remote commerce platform 110 is configured to return the card ID to the merchant 102. The merchant 102 is further configured to hash the FPAN and to store the hashed FPAN bound to the card ID, as part of the account of the user 124 with the merchant 102. The hashing may be based on one or more one-way hashing functions (e.g., MD5, SHA-1, SHA-256, SHA-3, etc.), whereby the hashed FPAN cannot generally be reversed to reveal the FPAN.

Next, in connection with a transaction between the user 124 and the merchant 102, the user 124 leverages the card device 122 to, generally, gain access to or use of product(s) of the merchant 102.

In connection therewith, the user 124 taps or presents the card device 122 to the wireless device 112. The card device 122 is configured to communicate the FPAN to the wireless device 112, as part of an application protocol data unit (APDU) message (e.g., which is defined as part of the ISO/IEC 7816-4 standard, etc.). The message is an R-APDU, which is a response, whereby the FPAN is included, along with the expiration date and CVC, in this example. In turn, the antenna 118 is configured to read/receive the R-APDU message from the card device 122, and to pass the R-APDU message to the NFC controller 120.

In this example embodiment, the NFC controller 120 is configured to generate a hash of the FPAN by the same one-way hashing function used above and to pass the hashed FPAN to the communication module 116. The NFC controller 120 is configured to flush or delete its secure memory, so that the FPAN is deleted, erased or eliminated from the NFC controller 120 (and thus, not-recallable by another operation). The communication module 116 is configured to then send the hashed FPAN to the merchant 102. The hashed FPAN may be accompanied by an identifier of the wireless device 112, or other suitable data, etc. Upon receipt of the hashed FPAN, the merchant 102 is configured to identify the user 124, by matching the hashed FPAN to a reference hashed FPAN in memory (as stored above). The merchant 102 is further configured to retrieve the card ID bound to the hashed FPAN.

The merchant 102 is configured to then initiate user confirmation of the transaction. That is, once the user 124 is identified, the merchant 102 is configured to request a PIN or passcode from the user 124, for example, via the wireless device 112, or otherwise. The user confirmation may further include authentication of the user 124, via the PIN, the passcode, a biometric, etc., as known by the merchant 102. Next, when the user confirmation is received, the merchant 102 is configured to submit a checkout request, via API, to the remote commerce platform 110. That is, the remote commerce platform 110 is configured to expose a checkout request API, which defines specific information to be submitted. In this example, then, the checkout request includes the retrieved card ID for the hashed FPAN and details of the transaction to be initiated (e.g., amount, currency, merchant ID, etc.).

In response, the remote commerce platform 110 is configured to generate a payload for the transaction, which includes the token for the card ID and a cryptogram. That is, the remote commerce platform 110 is configured to resolve the card ID into the token (e.g., alone or through the tokenization platform, etc.) and to generate the cryptogram based on the details of the transaction. The remote commerce platform 110 is configured to then return the payload to the merchant 102.

The merchant 102 is configured to submit the payload, or part thereof, to the PSP 104 as a request for authorization of the transaction. The PSP 104, in turn, is configured to compile an authorization request, which includes the token, the cryptogram, and certain details of the transaction. The PSP 104 is further configured to submit the authorization request to the issuer 108, through the processing network 106, whereby the token is resolved to the FPAN (by a tokenization platform of the processing network 106), which is added to the authorization request. The authorization request is consistent with one or more standards, including, specifically, the ISO 8583 standard, ISO 20022 standard, etc. In connection therewith, the issuer 108 is configured to review the authorization request, to decide whether to approve or decline the transaction, and to compile and submit an authorization reply back to the PSP 104, via the processing network 106. The authorization reply indicates the approval or decline of the transaction. The PSP 104 is configured to then provide, to the merchant 102, a confirmation of the success of the transaction, if approved, or confirmation of the failure of the transaction, if declined.

The merchant 102 is configured to provide the product(s) and/or access to the same to the user 124, if the transaction is successful.

According to a second implementation, the user 124, without enrolling the FPAN for access to product(s), taps or presents the card device 122 to the wireless device 112. The card device 122 is configured to communicate the FPAN and expiration date or expiry date to the wireless device 112, as part of an APDU message (e.g., which is defined as part of the ISO/IEC 7816-4 standard, etc.). The message includes, specifically, an R-APDU for responses, whereby the FPAN and expiration date are included in this example.

The antenna 118 is configured to read/receive the R-APDU message from the card device 122, and to pass the R-APDU message to the NFC controller 120. The NFC controller 120, in this implementation, is configured to encrypt the FPAN and expiration date with a public key received from the remote commerce platform 110. Next, the NFC controller 120 is configured to pass the encrypted FPAN and expiration date to the communication module 116 and to flush or delete the FPAN and expiration date from its secure memory, so that the FPAN and expiration date are deleted, erased or eliminated from the NFC controller 120 (and thus, not-recallable by another operation). The communication module 116 is configured to then submit the encrypted FPAN and expiration date to the merchant 102. The encrypted FPAN and expiration date may be accompanied by an identifier of the wireless device 112 or other suitable information, etc.

Upon receipt of the encrypted FPAN and expiration date, the merchant 102 is configured to submit a request for enrollment of the account, via an enrollment API exposed by the remote commerce platform 110. The request includes the encrypted FPAN and expiration date for the account, and additional data, as desired.

The remote commerce platform 110 is configured to decrypt the FPAN (and expiration date), using a private key thereof, and to verify that the account is eligible for tokenization with the issuer 108. If eligible, the remote commerce platform 110 is configured to determine a card ID for the account. In particular, the remote commerce platform 110 is configured to interact with a tokenization platform (not shown), which, in turn, is configured to generate a token unique to the FPAN, to assign a card ID to the token, and to return the card ID to the remote commerce platform 110. The tokenization platform also stores the card ID, which is linked to the token, and the token, which is linked to the FPAN, for later resolution of the same. As above, it should be appreciated that the tokenization platform may be integrated with the remote commerce platform 110 in one or more embodiments, or the remote commerce platform 110 and the tokenization platform may both be integrated into the processing network 106.

The remote commerce platform 110 is configured to provide the card ID to the merchant 102. In turn, in this example, the merchant 102 is configured to submit a checkout request, via API, to the remote commerce platform 110. As above, the remote commerce platform 110 is configured to expose a checkout request API, which defines specific information to be submitted. In this example, then, the checkout request includes the retrieved card ID for the hashed FPAN and details of the transaction to be initiated (e.g., amount, currency, merchant ID, etc.).

In response, the remote commerce platform 110 is configured to generate a payload, which includes the token for the card ID and a cryptogram. In connection therewith, the remote commerce platform 110 is configured to resolve the card ID into the token, through interacting with the tokenization platform, and to generate the cryptogram based on the details of the transaction. The remote commerce platform 110 is configured to then return the payload to the merchant 102.

The merchant 102 is configured to submit the payload, or part thereof, to the PSP 104 as a request for pre-authorization of the transaction. That is, in this example, because the FPAN is not enrolled or registered, the pre-authorization in combination with user confirmation is used prior to an authorization, as explained below. The PSP 104, in turn, is configured to initiate pre-authorization of the transaction based on the payload, including the token and the cryptogram, and also the details of the transaction. As such, the PSP 104 is configured to compile the pre-authorization request and to submit the pre-authorization request to the issuer 108, via the processing network 106, whereby the token is resolved to the FPAN (by the tokenization platform), which is added to the authorization request. The pre-authorization request is consistent with one or more standards, including, specifically, the ISO 8584 standard, ISO 20022 standard, etc. In connection therewith, the issuer 108 is configured to review the pre-authorization request, to determine to approve or decline the pre-authorization, to compile a pre-authorization reply, and to transmit the pre-authorization reply back to the PSP 104, via the processing network 106. The pre-authorization reply indicates the approval or decline of the transaction. The PSP 104 is configured to transmit to the merchant 102 a confirmation of the success of the pre-authorization, if approved.

The merchant 102 is configured to then initiate user confirmation of the transaction. The user confirmation may include a limited input from the user 124 to confirm user access, or the user’s approval of the transaction, etc. In one or more embodiments, the user 124 may be asked to enter a PIN, a passcode, or other indicator, to validate or verify his/her identity to the merchant 102, etc. In at least one embodiment, the merchant 102 communicates with a mobile device of the user 124, to solicit biometric or PIN authentication thereof, while in other embodiments, the merchant 102 solicits the authentication input through the wireless device 112 (e.g., a console touchscreen in the vehicle, etc.), etc.

Next, when the user confirmation is received, the merchant 102 is configured to submit the payload, or part thereof, to the PSP 104 as a request for authorization of the transaction. The PSP 104 is configured to compile an authorization request and to submit the authorization request to the issuer 108, through the processing network 106, whereby the token is resolved to the FPAN (by the tokenization platform), which is added to the authorization request. The authorization request is linked to the prior pre-authorization and consistent with one or more standards, including, specifically, the ISO 8583 standard, ISO 20022 standard, etc. In connection therewith, the issuer 108 is configured to decide to approve or decline the transaction, and then, to compile and submit an authorization reply indicating the same back to the PSP 104, via the processing network 106. The authorization reply indicates the approval or decline of the transaction. The PSP 104 is configured to provide to the merchant 102 a confirmation of the success of the transaction, if approved.

Based thereon, the merchant 102 is configured to provide the product(s) and/or access to the same to the user 124, if the transaction is successful.

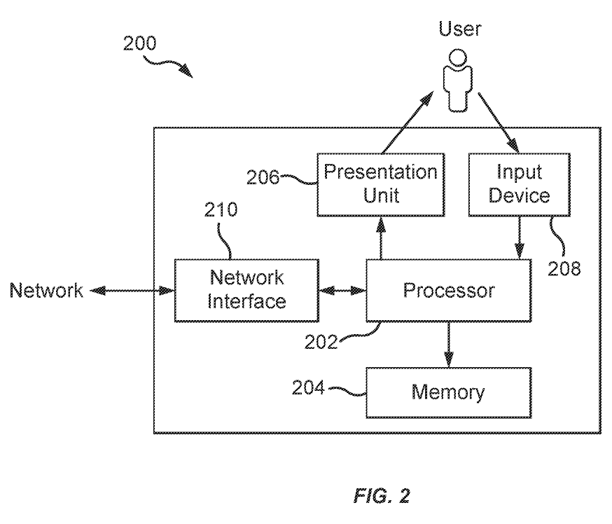

FIG. 2 illustrates an example computing device 200 that can be used in the system 100. The computing device 200 may include, for example, one or more servers, workstations, personal computers, laptops, tablets, smartphones, smartwatches, POS devices, etc. In addition, the computing device 200 may include a single computing device, or it may include multiple computing devices located in close proximity or distributed over a geographic region, so long as the computing devices are specifically configured to function as described herein. In particular, in the example system 100 of FIG. 1, each of the merchant 102, the PSP 104, the processing network 106, and the issuer 108 may include, or be implemented in, computing device 200, coupled to one or more networks, etc. In addition, the wireless device 112 and the card device 122 may each be considered a computing device, which is at least partially consistent with the computing device 200 (e.g., the wireless device 112 and/or the card device 122 may omit an output device, or input device, etc.). That said, however, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. For example, the wireless chip 114 may include a dedicated processor, which is configured to receives and transmit data via a wireless connection, to perform hashing or encryption (and to flush/delete data), and also to output certain data to one or more other processors within the wireless device 112. In this way, the wireless chip 114 is dedicated to wireless communication, with limited interactions for other purposes.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, credentials (e.g., PAN, expiration date, CVC, etc.), hashed/encrypted values, private/public keys, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition in the example embodiment, the computing device 200 includes an output device 206 that is coupled to (and is in communication with) the processor 202. The output device 206 outputs information, either visually or audibly, to a user of the computing device 200, for example, the wireless device 112, users associated with other parts of the system 100, etc. Various interfaces may also be displayed at computing device 200, and in particular at output device 206, to display such information. The output device 206 may include, without limitation, a presentation unit such as a liquid crystal display (LCD), a light-emitting diode (LED) display, an organic LED (OLED) display, an “electronic ink” display; speakers; another computer; etc. In some embodiments, the output device 206 may include multiple devices.

The computing device 200 also includes an input device 208 that receives inputs from the user of the computing device 200 (i.e., user inputs) such as, for example, authentication inputs, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the output device 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks. In this example embodiment, as it relates to the wireless device 112 and the wireless chip 114, each may be or may include the network interface 210 for NFC communication. Further, in some example embodiments, the computing device 200 may include the processor 202 and one or more network interfaces (including the network interface 210) incorporated into or with the processor 202.

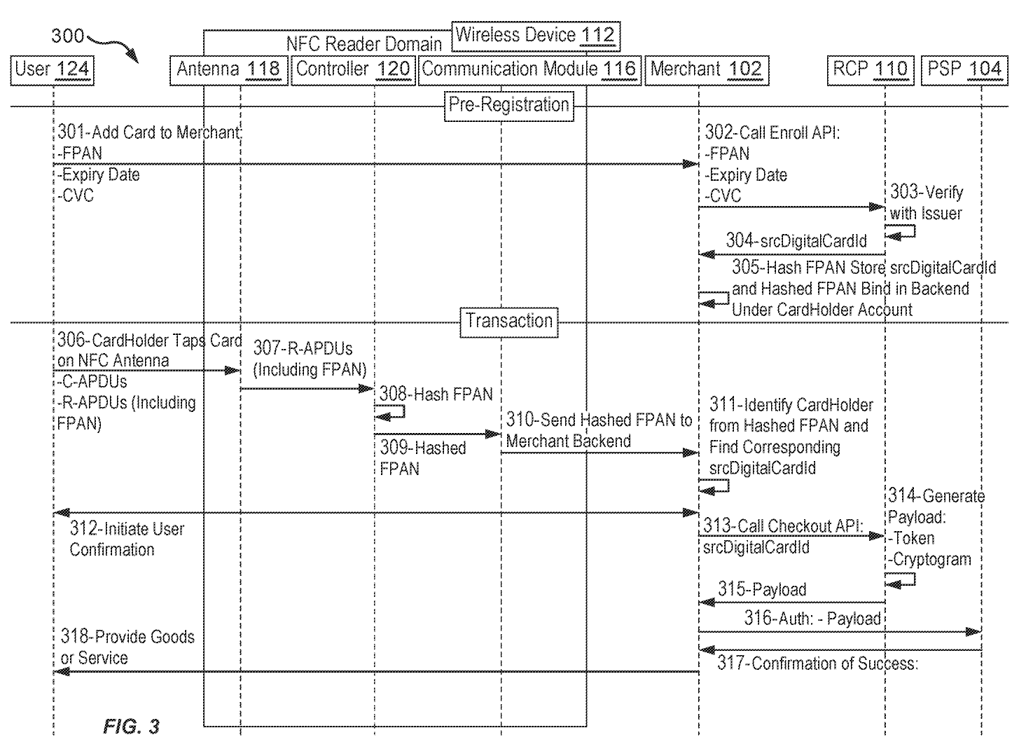

FIG. 3 illustrates an example method 300 for use in data compliance for certain data read, from a device, via NFC. The example method 300 is described with reference to the system 100, and also reference to the computing device 200. However, it should be understood that the method 300 (and other methods herein) are not limited to the system 100 or the computing device 200, as the method 300, for example, may be implemented, at least in part, in other parts of suitable systems, or in multiple other computing devices or systems. Likewise, the systems and the computing devices herein (including the system 100 and the computing device 200) should not be understood to be limited to the example method 300.

At 301, the user instructs the merchant 102 to add an account as a card on file with the merchant 102. In particular, in this example, the user 124, for instance, may issue the instruction from a mobile device, such as a smartphone, or another computing device (e.g., a laptop, a desktop, etc.). The instruction may be initiated at a webpage of the merchant 102, in general, or as part of a checkout process, etc. As shown, the instruction includes a funding primary account number or FPAN for the account, an expiration date and a CVC. It should be appreciated that other data may be included in the instruction, as necessary or desired.

It should also be appreciated that the user 124 may further be logged into an account with the merchant 102, such as, for example, at the webpage or application of the merchant 102, etc., whereby the identity of the user 124 is verified (e.g., by biometrics, password, PIN, etc.).

At 302, the merchant 102 submits a request for enrollment of the account, via an application programming interface (API) of the remote commerce platform 110 (RCP 110 in FIG. 3). The request includes the FPAN along with the expiration date and CVC for the account, as included in the instruction. At 303, the remote commerce platform 110 verifies with the issuer 108 that the account is eligible for tokenization. If eligible, the remote commerce platform 110 determines a card ID (i.e., scrDigitalCardId) for the account. In particular, the remote commerce platform 110 interacts with a tokenization platform (not shown), which generates a token unique to the account/FPAN, assigns a card ID to the specific token, and then returns the card ID to the remote commerce platform 110. The tokenization platform also stores the card ID, which is linked to the token, and the token, which is linked to the FPAN, for later resolution of the same. It should be appreciated that the tokenization platform may be integrated with the remote commerce platform 110 in one or more embodiments.

The remote commerce platform 110 returns, at 304, the card ID to the merchant 102.

At 305, the merchant 102 hashes the FPAN and stores the hashed FPAN, which is bound to the card ID in memory, as part of the account of the user 124 with the merchant 102. The hashing is accomplished through a one-way hashing function, whereby the hashed value cannot be reversed to reveal the FPAN. The hashed value is consistently produced from the hashing function where the input value is the same, i.e., the same hash value is generated for the same FPAN. In this way, the pre-registration phase of the method 300 for the account is complete.

Thereafter, the user 124 may interact with the merchant 102 to secure one or more products (e.g., goods, services, etc.). In connection therewith, the user 124 opts to access (or pay for) the products through the card device 122. It should be appreciated that the type of access may be dependent on the type of product(s). For a car rental, for example, the access may include unlocking or starting a vehicle, etc. In this example, the user 124 interacts with the merchant 102 to identify the rental period, pickup date, etc., whereby the merchant 102 compiles a rental instance, which includes these details and also the details of the user 124. Regardless of the merchant type, though, the access is provided through the wireless device 112, which, again, is associated with the merchant 102 (e.g., the rental vehicle, etc.).

Based on the above, the user 124 travels to the wireless device 112 (e.g., a rental vehicle, etc.) and taps or presents the card device 122 to the wireless device 112, at 306. As part thereof, the FPAN is communicated to the wireless device 112, as part of an application protocol data unit (APDU) message (e.g., which is defined as part of the ISO/IEC 7816-4 standard, etc.). The message may be a C-APDU for commands or an R-APDU for responses, whereby the FPAN is included, along with the expiration date and CVC, in a R-APDU, in this example.

In turn, the antenna 118 reads/receives the R-APDU message from the card device 122, and passes, at 307, the R-APDU message including the FPAN to the NFC controller 120. The NFC controller 120, in turn, at 308, generates a hash of the FPAN, and passes, at 309, the hashed value for the FPAN to the communication module 116. The NFC controller 120 further flushes or deletes its secure memory, so that the FPAN is deleted or eliminated from the NFC controller 120 (and thus, not-recallable by another operation). The wireless device 112, and the communication module 116, specifically, sends, at 310, the hashed FPAN to the merchant 102. The hashed FPAN may be accompanied by an identifier of the wireless device 112 (e.g., license plate number, VIN, electronic ID, etc.), etc.

Upon receipt of the hashed FPAN, the merchant 102 identifies, at 311, the user 124 from the hashed FPAN. That is, the merchant 102 performs a lookup for the hashed FPAN among the hashed values in memory of the merchant 102 (e.g., which is non-PCI data, etc.) to identify the user 124 (as included in the account of the user 124, at the merchant 102, through pre-registration). Once identified, at 311, the merchant 102 further retrieves the card ID for the account/token.

At 312, the merchant 102 initiates user confirmation of the transaction. The user confirmation may include a limited input from the user 124 to confirm user access, or user’s approval of the transaction, etc. In one or more embodiments, the user 124 may be asked to enter a PIN, or other indicator to validate or verify his/her identity to the merchant 102, etc. In at least one embodiment, the merchant 102 communicates with a mobile device of the user 124, to solicit biometric or PIN authentication thereof, while in other embodiments, the merchant 102 solicits the authentication input through the wireless device 112 (e.g., a console touchscreen in the vehicle, etc.), etc.

The merchant 102 then submits, at 313, a checkout request to the remote commerce platform 110, via an API call thereto. The checkout request includes the card ID for the hashed FPAN and also details of the transaction to be initiated (e.g., amount, currency, merchant ID, etc.). In response, the remote commerce platform 110 generates, at 314, a payload, which includes the token for the card ID and a cryptogram. In connection therewith, the remote commerce platform 110 resolves the card ID into the token (e.g., alone or through the tokenization platform, etc.) and generates the cryptogram based on the details of the transaction. At 315, the remote commerce platform 110 returns the payload to the merchant 102.

The merchant 102 submits, at 316, the payload, or part thereof, to the PSP 104 as a request for authorization of the transaction. The PSP 104, in turn, initiates authorization of the transaction based on the payload, including the token and the cryptogram, and also the details of the transaction. As such, the PSP 104 compiles and submits an authorization request to the issuer 108, through the processing network 106. The authorization request is consistent with one or more standards, including, specifically, the ISO 8583 standard, the ISO 20022 standard, etc. In connection therewith, the issuer 108 decides to approve or decline the transaction, and then compiles and submits an authorization reply back to the PSP 104, via the processing network 106. The authorization reply indicates the approval or decline of the transaction. At 317, the PSP 104 provides to the merchant 102 a confirmation of the success of the transaction (when approved).

In turn, the merchant 102 provides, at 318, the products (e.g., goods, services, etc.) to the user 124. In the rental vehicle example, the merchant 102 enables the vehicle to be driven consistent with the rental instance.

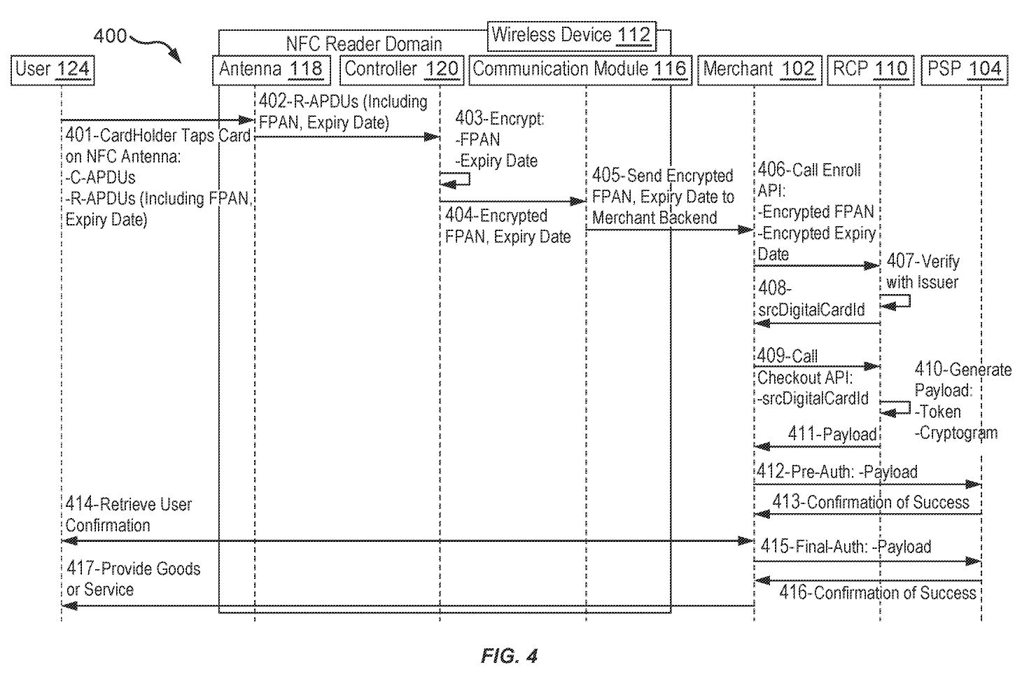

FIG. 4 illustrates an example method 400 for use in data compliance for certain data read from a device, via NFC. The example method 400 is described with reference to the system 100, and also reference to the computing device 200. However, it should be understood that the method 400 (and other methods herein) are not limited to the system 100 or the computing device 200, as the method 400, for example, may be implemented, at least in part, in other parts of suitable systems, or in multiple other computing devices or systems. Likewise, the systems and the computing devices herein (including the system 100 and the computing device 200) should not be understood to be limited to the example method 400.

At the outset, the user 124 may interact with the merchant to secure one or more products (e.g., goods, services, etc.). In connection therewith, the user 124 opts to access the products through/via the card device 122. As described above, it should be appreciated that the type of access may be dependent on the type of product(s). The access is then provided through the wireless device 112, which, again, is associated with the merchant 102.

It should also be appreciated that such an interaction may be omitted in other methods, depending on, for example, the relationship between the user 124 and the merchant 102, or lack thereof, etc.

Based on the above, without pre-registering the card device 122, in this example method, the user 124 travels to the wireless device 112 (e.g., a rental vehicle, etc.) and taps or presents the card device 122 to the wireless device 112, at 401. As part thereof, the FPAN and expiration date are communicated to the wireless device 112, as part of an APDU message (e.g., which is defined as part of the ISO/IEC 7816-4 standard, etc.). The message includes, specifically, an R-APDU for responses, whereby the FPAN and expiration date are included in this example.

In turn, the antenna 118 reads/receives the R-APDU message from the card device 122, and passes, at 402, the R-APDU message including the FPAN and expiration date to the NFC controller 120. The NFC controller 120, in turn, at 403, encrypts the FPAN and expiration date with a public key received from the remote commerce platform 110. Next, at 404, the NFC controller 120 passes the encrypted FPAN and expiration date to the communication module 116. The NFC controller 120 further flushes or deletes its secure memory, so that the FPAN and expiration date are deleted or eliminated from the NFC controller 120 (and thus, not-recallable by another operation). The wireless device 112, and the communication module 116, specifically, then sends, at 405, the encrypted FPAN and expiration date to the merchant 102. The encrypted FPAN and expiration date may be accompanied by an identifier of the wireless device 112 (e.g., license plate number, VIN, electronic ID, etc.), in one or more examples, etc.

Upon receipt of the encrypted FPAN and expiration date, the merchant 102 submits, at 406, a request for enrollment of the account, via an API of the remote commerce platform 110. The request includes the encrypted FPAN and expiration date for the account, and additional data, as desired.

At 407, the remote commerce platform 110 decrypts the FPAN (and expiration date), using a private key thereof, and verifies with the issuer 108 that the account is eligible for tokenization. If eligible, the remote commerce platform 110 determines a card ID (i.e., scrDigitalCardId) for the account. In particular, the remote commerce platform 110 interacts with a tokenization platform (not shown), which generates a token unique to the account/FPAN, assigns a card ID to the specific token, and then returns the card ID to the remote commerce platform 110. The tokenization platform also stores the card ID, which is linked to the token, and the token, which is linked to the FPAN, for later resolution of the same. As above, it should be appreciated that the tokenization platform may be integrated with the remote commerce platform 110 in one or more embodiments.

The remote commerce platform 110 returns, at 408, the card ID to the merchant 102.

The merchant 102 then submits, at 409, a checkout request to the remote commerce platform 110, via an API call thereto. The checkout request includes the card ID and also details of the transaction to be initiated (e.g., amount, currency, merchant ID, etc.). In response, the remote commerce platform 110 generates, at 410, a payload, which includes the token for the card ID and a cryptogram. In connection therewith, the remote commerce platform 110 resolves the card ID into the token (e.g., alone or through the tokenization platform, etc.) and generates the cryptogram based on the details of the transaction. At 411, the remote commerce platform 110 returns the payload to the merchant 102.

It should be appreciated that verifying with the issuer 108 and generating the payload may be consolidated into a single interaction with the remote commerce platform 110 in one or more implementations (whereby the card ID is not returned to the merchant 102).

The merchant 102 submits, at 412, the payload, or part thereof, to the PSP 104 as a request for pre-authorization of the transaction. The PSP 104, in turn, initiates pre-authorization of the transaction based on the payload, including the token and the cryptogram, and also the details of the transaction. As such, the PSP 104 compiles and submits a pre-authorization request to the issuer 108, via the processing network 106. The pre-authorization request is consistent with one or more standards, including, specifically, the ISO 8584 standard, the ISO 20022 standard, etc. In connection therewith, the issuer 108 decides to approve or decline the pre-authorization and then compiles and submits a pre-authorization reply back to the PSP 104, via the processing network 106. The pre-authorization reply indicates the approval or decline of the transaction. At 413, the PSP 104 provides to the merchant 102 a confirmation of the success of the pre-authorization (when approved).

In turn, the merchant 102 initiates, at 414, user confirmation of the transaction. The user confirmation may include a limited input from the user 124 to confirm user access, or user’s approval of the transaction, etc. In one or more embodiments, the user 124 may be asked to enter a PIN, or other indicator, to validate or verify his/her identity to the merchant 102, etc. In at least one embodiment, the merchant 102 communicates with a mobile device of the user 124, to solicit biometric or PIN authentication thereof, while in other embodiments, the merchant 102 solicits the authentication input through the wireless device 112 (e.g., a console touchscreen in the vehicle, etc.), etc.

Based on the user confirmation, the merchant 102 submits, at 415, the payload, or part thereof, to the PSP 104 as a request for authorization of the transaction. The PSP 104, in turn, initiates authorization of the transaction based on the payload, including the token and the cryptogram, and also the details of the transaction. As such, the PSP 104 compiles and submits an authorization request to the issuer 108, through the processing network 106. The authorization request is linked to the prior pre-authorization and is consistent with one or more standards, including, specifically, the ISO 8583 standard, the ISO 20022 standard, etc. In connection therewith, the issuer 108 decides to approve or decline the transaction, and then compiles and submits an authorization reply back to the PSP 104, via the processing network 106. The authorization reply indicates the approval or decline of the transaction. At 416, the PSP 104 provides to the merchant 102 a confirmation of the success of the transaction (when approved).

In turn, the merchant 102 provides, at 417, the products (e.g., goods, services, etc.) to the user 124. In the rental vehicle example, the merchant 102 enables the vehicle to be driven consistent with the rental instance.

In connection with the above, systems and methods herein may enable non-PCI PIN transaction security (PTS) wireless readers, for example, for card-on-file payments by only handling non-PCI data read from payment devices, such as, for example, card devices and/or tokenized devices. Additionally, or alternatively, systems and method herein may enable non-PCI PTS wireless readers, for example, for tokenized guest payments by only handling encrypted end to end sensitive data “on the fly” (from the payment devices) and convert it to non-PCI data. In particular, for example, for an interaction device, which receives sensitive data, the device is specifically configured to hash and/or encrypt the received data, as it is received (i.e., at the time of collection), and to promptly flush or delete memory thereof, whereby exposure of the data beyond the device is limited, or eliminated. The hashed or encrypted data may then be used in place of the data (e.g., account numbers, etc.), in data flows, to enable the data to be used to access goods, services, etc.

In this way, conventional wireless devices (e.g., card devices, tokenized devices, etc.) are generally unchanged, while systems and methods as described herein and consistent with the above employ the conventional wireless devices in a manner that provides enhanced data security and secure access to product(s).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims, including: (a) receiving an application protocol data unit (APDU) message from a near-field communication (NFC) enabled device, the APDU message including a credential; (b) hashing, using a one-way hashing function, or encrypting, using a public key associated with a remote commerce platform, the credential upon receipt of the APDU from the antenna; (c) flushing a secure memory of the controller after hashing or encrypting the credential; and/or (d) transmitting the hashed or encrypted credential to a communication module of the wireless device, whereby the hashed or encrypted credential is submitted to a first party to enable access to the wireless device.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in data compliance for certain data read from a device, the system comprising:
a wireless device including an antenna and a controller coupled to the antenna;
wherein the antenna is configure to receive an application protocol data unit (APDU) message from a near-field communication (NFC) enabled device, the APDU message including a credential; and
wherein the controller is configured to:
receive the APDU message from the antenna;
hash, using a one-way hashing function, the credential, upon receipt of the APDU from the antenna;
flush a secure memory of the controller after hashing the credential; and
transmit the hashed credential to a communication module of the wireless device, whereby the hashed credential is submitted to a first party to enable access to the wireless device.

2. The system of claim 1, wherein the wireless device includes the communication module, which is configured to submit the hashed credential to the first party.

3. The system of claim 1, further comprising a computing device of the first party, which is configured to:
receive the hashed credential from the wireless device;
identify a card ID based on the hashed value matching a reference hashed value, which is bound to the card ID; and
submit a checkout request including the card ID to a remote commerce platform.

4. The system of claim 3, wherein the computing device is configured to:
receive a first credential from a user of the account;
hash, via the one-way hashing function, the first credential;
store the hashed first credentials as the reference hashed credential; and
bind the card ID to the reference hashed credential.

5. The system of claim 1, wherein the controller is configured, in order to flush the secure memory of the controller after hashing the credential, to delete or erase the credential from the secure memory.

6. A system for use in in data compliance for certain data read from a device, the system comprising:
a wireless device including an antenna and a controller coupled to the antenna;
wherein the antenna is configure to receive an application protocol data unit (APDU) message from a near-filed communication (NFC) enabled device, the APDU message including a credential; and
wherein the controller is configured to:
receive the APDU from the antenna;
encrypt, using a public key associated with a remote commerce platform, the credential, upon receipt of the APDU from the antenna;
flush a secure memory of the controller after encrypting the credential; and
transmit the encrypted credential to a communication module of the wireless device, whereby the encrypted credential is submitted to a first party to enable access to the wireless device.

7. The system of claim 6, wherein the wireless device includes the communication module, which is configured to submit the encrypted credential to the first party.

8. The system of claim 6, further comprising a computing device of the first party, which is configured to:
receive the encrypted credential from the wireless device;
submit an enrollment request for the account, the enrollment request including the encrypted credential;
receive, in response to the enrollment request, a card ID for the account; and
submit a checkout request including the card ID to the remote commerce platform.

9. The system of claim 6, wherein the controller is configured, in order to flush the secure memory of the controller after hashing the credential, to delete or erase the credential from the secure memory.

10. A computer-implemented method for use in data compliance for certain data read from a device, the computer-implemented method comprising:
receiving, by a controller of a wireless device, via an antenna of the wireless device, an application protocol data unit (APDU) message from a near-field communication (NFC) enabled device, the APDU message including a credential;
hashing, using a one-way hashing function, or encrypting, using a public key associated with a remote commerce platform, the credential, by the controller, upon receipt of the APDU from the antenna;
flushing, by the controller, a secure memory of the controller after hashing or encrypting the credential; and
transmitting, by the controller, the hashed or encrypted credential to a communication module of the wireless device, whereby the hashed or encrypted credential is submitted to a first party to enable access to the wireless device.

11. The computer-implemented method of claim 10, further comprising submitting, by the communication module, the hashed or encrypted credential to the first party.

12. The computer-implemented method of claim 10, wherein hashing or encrypting the credential includes hashing the credential; and
wherein the method further comprises:
receiving, by a computing device of the first party, the hashed credential from the wireless device;
identifying, by the computing device of the first party, a card ID based on the hashed value matching a reference hashed value, which is bound to the card ID; and
submitting, by the computing device of the first party a checkout request including the card ID to a remote commerce platform.

13. The computer-implemented method of claim 12, further comprising:
receiving, by the computing device of the first party, a first credential from a user of the account;
hashing, by the computing device of the first party, via the one-way hashing function, the first credential;
storing, by the computing device of the first party, the hashed first credentials as the reference hashed credential; and
binding, by the computing device of the first party, the card ID to the reference hashed credential.

14. The computer-implemented method of claim 10, wherein hashing or encrypting the credential includes encrypting the credential; and
wherein the method further comprises:
receiving, by a computing device of the first party, the encrypted credential from the wireless device;
submitting, by the computing device of the first party, an enrollment request for the account, the enrollment request including the encrypted credential;
receiving, by the computing device of the first party, in response to the enrollment request, a card ID for the account; and
submitting, by the computing device of the first party, a checkout request including the card ID to the remote commerce platform.

15. The computer-implemented method of claim 10, wherein flushing the secure memory of the controller after hashing or encrypting the credential includes deleting or erasing the credential from the secure memory.
